(19) United States
(12) Patent Application Publication
(10) Pub. No.: US 2026/0106399 A1
(43) Pub. Date: Apr. 16, 2026

(54) MODULAR ELECTRICAL CONNECTOR ASSEMBLY

(71) Applicant: STÄUBLI ELECTRICAL CONNECTORS AG, Allschwil (CH)

(72) Inventors: Dustin Delmar Reede CARVER, Windsor, CA (US); Max KATZ, San Jose, CA (US); Grayson MAURER, Grass Valley, CA (US); Brian Wade MILLS, Santa Rosa, CA (US); Lee Michael WADE, Windsor, CA (US); Andrew HOWARD, Windsor, CA (US)

(73) Assignee: STÄUBLI ELECTRICAL CONNECTORS AG, Allschwil (CH)

(21) Appl. No.: 19/111,920

(22) PCT Filed: Sep. 5, 2023
(86) PCT No.: PCT/EP2023/074231

§ 371 Date: Mar. 14, 2025

Related U.S. Application Data
(60) Provisional application No. 63/406,934, filed on Sep. 15, 2022.
(60) Provisional application No. 63/406,939, filed on Sep. 15, 2022.
(60) Provisional application No. 63/406,944, filed on Sep. 15, 2022.

(51) Int. Cl. H01R 13/506

(52) U.S. Cl. CPC H01R 13/506

(57) ABSTRACT

Modular electrical connector assembly having a socket carrier element having a bearing section, a mating structure and a carrier structure to carry at least one electrical socket element; a pin carrier element having a bearing section, a mating structure and a carrier structure to carry at least one electrical pin element; a socket housing with a receiving section to which the socket carrier element is mounted by the bearing section and with a housing section; and a pin housing with a receiving section to which the pin carrier element is mounted by the bearing section and with a housing section. The bearing section of the socket carrier element is identical to the bearing section of the pin carrier element and the receiving section of the socket housing is identical to the receiving section of the pin housing.

### TECHNICAL FIELD

The present invention relates to a modular electrical connector assembly according to claim 1 and an assembly kit according to claim 13.

### PRIOR ART

Electrical connector assemblies are known from prior art.

### SUMMARY OF THE INVENTION

It is an object of the present invention to provide a modular electrical connector assembly wherein the individual parts are provided such that a modular structure can be achieved.

This object is solved by the electrical connector assembly according to claim 1. According to claim 1 a modular electrical connector assembly comprises a socket carrier element having a bearing section, a mating structure and a carrier structure to carry at least one electrical socket element; a pin carrier element having a bearing section, a mating structure and a carrier structure to carry at least one electrical pin element; a socket housing with a receiving section to which the socket carrier element is mounted by means of the bearing section and with a housing section; and a pin housing with a receiving section to which the pin carrier element is mounted by means of the bearing section and with a housing section. The mating structure of the socket carrier element mechanically mates with the mating structure of the pin carrier element. The at least one electrical socket element and the at least one electrical pin element are arranged such that when the socket carrier element is mated with the pin carrier element an electrical contact is provided between the at least one electrical socket element and the at least one electrical pin element. The bearing section of the socket carrier element is identical to the bearing section of the pin carrier element and the receiving section of the socket housing is identical to the receiving section of the pin housing.

Due to the identical bearing sections and receiving sections a standardised interface is provided between the carrier elements and the housing such that a modular system can be provided.

Preferably, each of the carrier elements is provided as a one-piece element. Preferably, each of the carrier elements is made out of plastic, such as a fibre reinforced plastic, in particular a fibre reinforced polyamide such as nylon for example.

Preferably, each of the housing elements is provided as a one-piece element. Preferably, each of the housing elements is made out of plastic, such as a fibre reinforced plastic, in particular a fibre reinforced polyamide such as nylon for example.

Preferably, the bearing section comprises a cylindrical section and wherein the receiving section comprises a cylindrical section, wherein the cylindrical sections mechanically engage with each other.

Preferably, the cylindrical section of the bearing section is an outer surface and the cylindrical section of the receiving section is an inner surface, wherein the outer surface comes into contact with the inner surface. Alternatively, the cylindrical section of the bearing section is an inner surface and the cylindrical section of the receiving section is an outer surface, wherein the outer surface comes into contact with the inner surface.

Preferably, the bearing section comprises a stop surface and wherein the receiving section comprises a stop surface, wherein the stop surfaces engage with each other.

Preferably, the stop surface are angularly inclined to a direction along which the respective carrier element is mounted to the respective housing.

Preferably, the bearing section comprises a latching structure and wherein the receiving section comprises a latching structure, wherein the latching structures mechanically latch with each other.

Preferably, the latching structure is provided by a latching tab and a latching rib, wherein the latching rib engages with the latching tab,
wherein the latching tab is arranged on the housing and extends away from the housing and the latching rib is arranged on the carrier element; or
wherein the latching tab is arranged on the carrier element and extends away from the carrier element and the latching rib is arranged on the housing.

Preferably, at least two of said latching tabs and at least two of said latching ribs are arranged, wherein the latching tabs are arranged diametrically opposite on the housing or diametrically opposite on the carrier element; and wherein the latching ribs are arranged diametrically opposite on the housing or diametrically opposite on the carrier element.

Preferably, on the carrier element the cylindrical section is adjoined by the stop surface and the latching structure is arranged on the side of the stop surface opposite the cylindrical section.

Preferably, the bearing section comprises a first guiding element and the receiving section comprises a second guiding element, wherein the first guiding element engages with the second guiding element such that a determined orientation between the carrier element and the housing can be provided.

Preferably, the carrier element comprises several indentations, which are arranged such that they remain uncovered when the carrier element is mounted to the housing.

Preferably, the indentations are arranged on the side of the stop surface opposite the cylindrical section.

Preferably, the mating structure of one of the carrier elements comprises a mating opening and wherein the mating structure of the other of the carrier elements comprises a mating shaft which engages with the mating opening.

Preferably, each of the mating structures comprise a coding ring having at least one coding element, wherein the coding rings can be positioned at different predetermined coding positions.

An assembly kit for a modular connector assembly according to the description above comprises
at least one socket carrier element;
at least one pin carrier element;
at least one socket housing;
at least one pin housing; and
at least one further housing with a further receiving section to which one of said socket carrier element or said pin carrier element can be mounted by means of the bearing section and with a further housing section. The housing sections of the housings are different from each other. The bearing sections of the socket carrier element is identical to the bearing section of the pin carrier element. The receiving section of the housings are identical to each other.

As all the housings have an identical receiving section, the socket carrier element and the pin carrier element can be modularly connected to the respective housing with the respective housing section. The user can thereby choose a housing which is appropriate for the respective use.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows perspective view of the modular connector assembly with a first connector and a second connector according to the following figures;

FIG. 2 shows a further perspective view of FIG. 1;

FIG. 3 shows an exploded view of a modular connector of the connector assembly according a preferred embodiment;

FIG. 4 shows a further detailed view of FIG. 3;

FIG. 5 shows a perspective view of a modular connector of the connector assembly according a preferred embodiment;

FIG. 6 shows a further perspective view of FIG. 5;

FIG. 7 shows a further modular connector in perspective view;

FIG. 8 shows a further perspective view of FIG. 7; and

FIG. 9 shows a detailed view of the housing of FIGS. 7 and 8.

### DESCRIPTION OF PREFERRED EMBODIMENTS

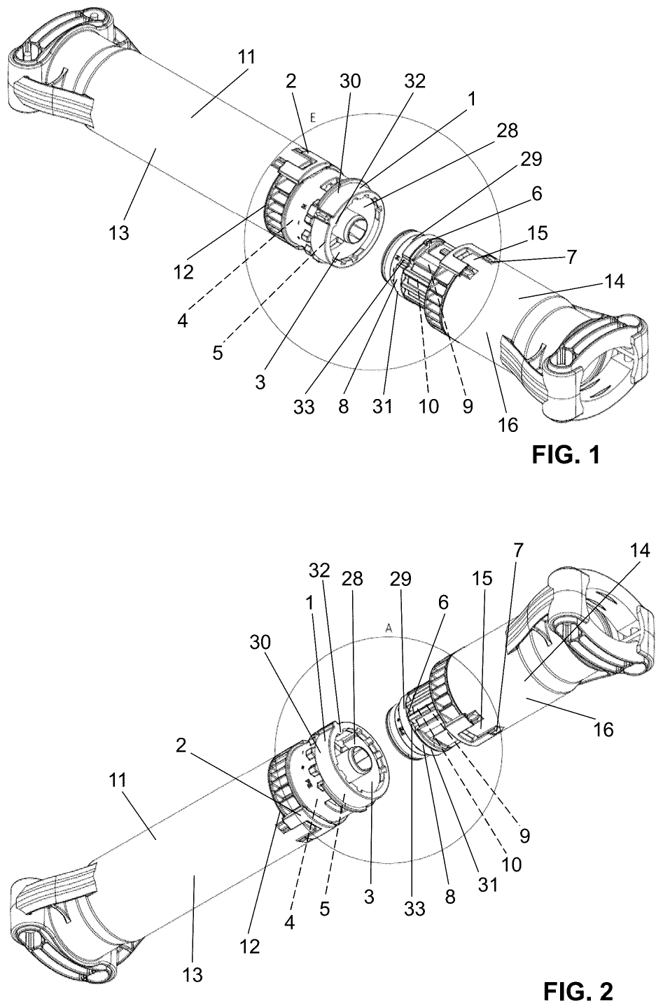

FIGS. 1 and 2 show a modular connector assembly according to an embodiment of the present invention. The modular connector assembly comprises a socket carrier element 1, a pin carrier element 6, a socket housing 11 and a pin housing 14. The socket carrier element 1 is mechanically connected to the socket housing 11, wherein a socket side connector is provided. The pin carrier element 6 is mechanically connected to the pin housing 14, wherein a pin side connector is provided. The socket side connector and the pin side connector can be connected with each other.

The socket carrier element 1 comprises a bearing section 2, a mating structure 3 and a carrier structure 4 to carry at least one electrical socket element 5. The pin carrier element 6 comprises a bearing section 7, a mating structure 8 and a carrier structure 9 to carry at least one electrical pin element 10. The mating structure 3 of the socket carrier element 1 mechanically mates with the mating structure 8 of the pin carrier element 6. The at least one electrical socket element 5 and the at least one electrical pin element 10 are arranged such in the respective carrier element 1, 6 that when the socket carrier element 1 is mated with the pin carrier element 6 an electrical contact is provided between the at least one electrical socket element 5 and the at least one electrical pin element 10. The electrical socket element 5 comprises a socket section and the electrical pin element 10 comprises a pin section which engages in said socket section. Preferably, an electrical contact device with spring loaded contact elements is arranged between the socket section and the pin section to establish an electrical contact between the pin section and the socket section.

The socket housing 11 comprises a receiving section 12 to which the socket carrier element 1 is mounted by means of the bearing section 2 and a housing section 13. The pin housing 14 comprises a receiving section 15 to which the pin carrier element 6 is mounted by means of the bearing section 8 and a housing section 16. In the present embodiment, the housing section 13 of the socket housing 11 is provided differently from the housing section 16 of the pin housing 14.

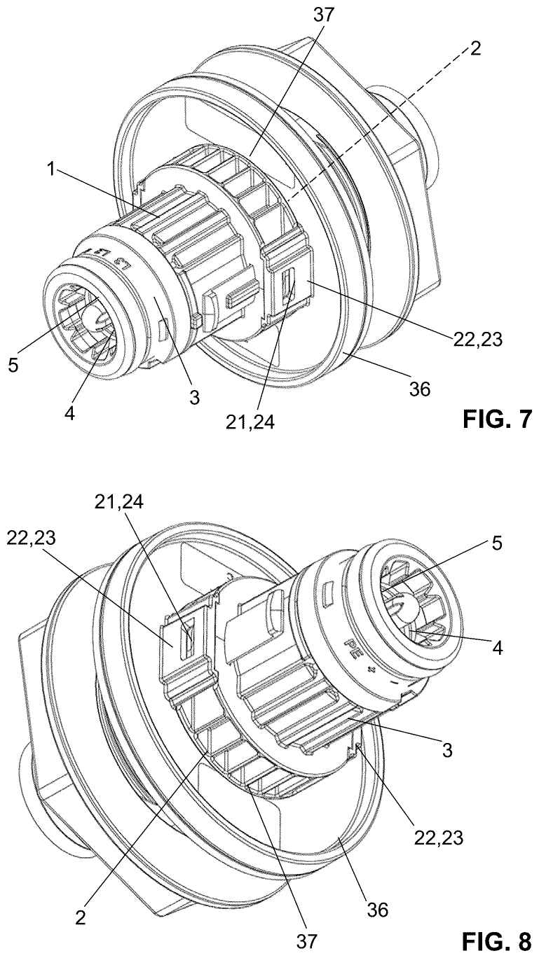

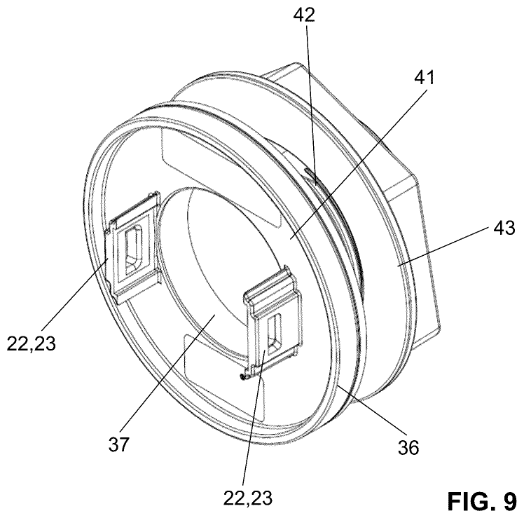

The bearing section 2 of the socket carrier element 1 is identical to the bearing section 7 of the pin carrier element 6. The receiving section 12 of the socket housing 11 is identical to the receiving section 15 of the pin housing 14. With regard to FIGS. 7 to 9 a further connector with a further housing 36 is shown. The further housing 36 has a receiving section 37, which is identical to the receiving section 12 of the socket housing 11 and to the receiving section 15 of the pin housing 14. The further housing 36 is here connected to a socket carrier element 1.

Due to the identical bearing sections 2, 7 and the identical receiving sections 12, 15, 37 a standardised interface is provided between the carrier elements 1, 6 and the housings 11, 14, 36 such that a modular assembly system can be provided.

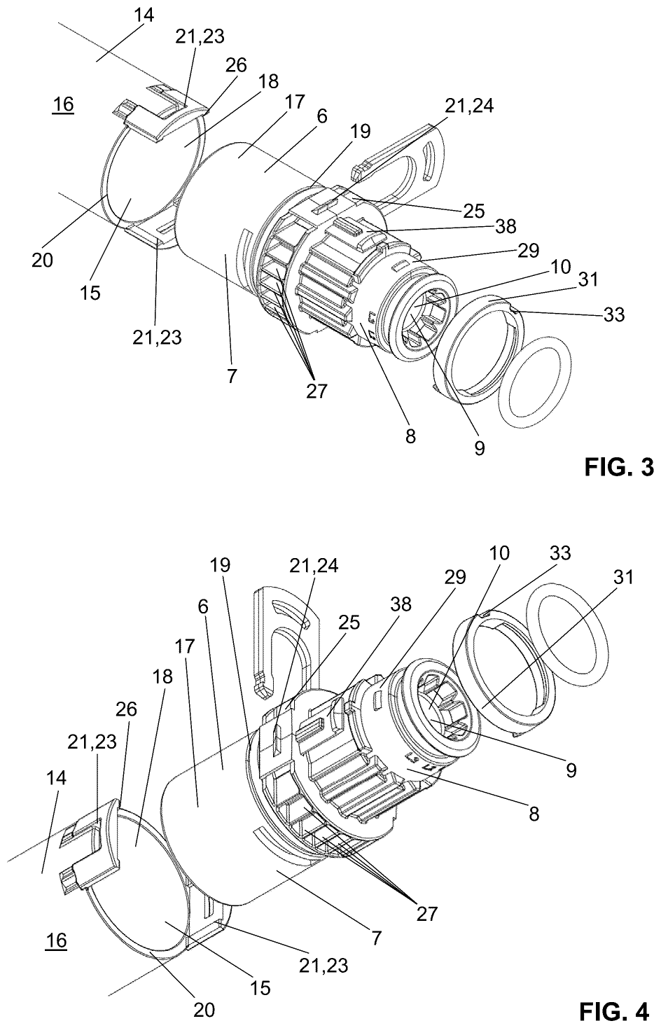

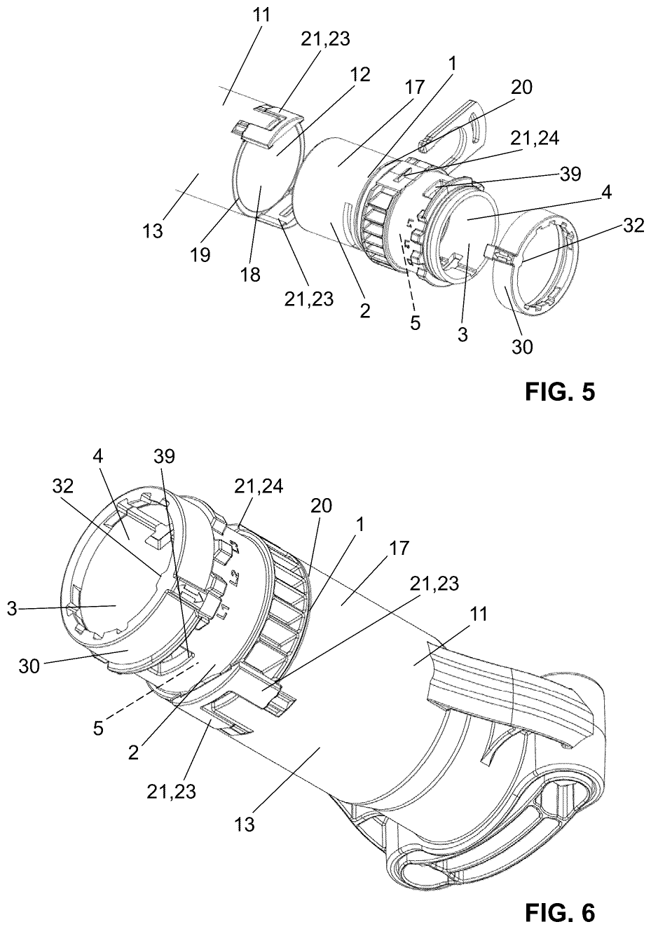

With the embodiments as shown in FIGS. 3 to 6 the preferred mechanical structure is now explained in more details. Thereby it is referred to the socket carrier element as well as to the pin carrier element and to the socket housing as well as to the pin housing. FIGS. 3 to 4 show a pin housing and FIGS. 5 to 6 show a socket housing.

The bearing section 2, 7 of the carrier element 1, 6 comprises a cylindrical section 17. The receiving section 12, 15 of the housings 11, 14 comprises a cylindrical section 18. The cylindrical section 17 is here a circular cylindrical outer surface and the cylindrical section 18 is here a circular cylindrical inner surface. The cylindrical sections 17, 18 mechanically engage with each other.

The bearing section 2, 7 of the carrier element 1, 6 comprises a stop surface 19. The receiving section 12, 15 of the housings 11, 14 comprises a stop surface 20, wherein the stop surfaces 19, 20 engage with each other. The stop surface 19 on the carrier element 1, 6 is arranged adjacent to the cylindrical section 17 and the stop surface 20 on the housing 11, 14 is arranged adjacent to the cylindrical section 18. The stop surface 19, 20 are oriented perpendicular to a middle axis through the cylindrical section 17, 18.

The bearing section 2, 7 comprises a latching structure 21 and the receiving section 12, 15 comprises a latching structure 22. The latching structures 21, 22 are provided such that they mechanically latch with each other. The latching structure 21 is provided by a latching tab 23 and the latching structure 22 is provided by a latching rib 24. The latching rib 24 engages with the latching tab 23. In the present embodiments the latching tab 23 is arranged on the housing 11, 14 and extends away from the housing 11, 14 and the latching rib 24 is arranged on the carrier element 1, 6. The latching tab 24 extends away from the stop surface 20 of the housing 11, 14. The latching rib 23 is arranged, as seen in mounting direction between the carrier element and the housing, behind the stop surface 19 of the carrier element 1, 6.

Preferably, the bearing section 2, 7 comprises a first guiding element 25 and the receiving section 12, 15 comprises a second guiding element 26, wherein the first guiding element 25 engages with the second guiding element 26 such that a determined orientation between the carrier element 1, 6 and the housing 11, 14 can be provided. The guiding elements 25, 26 can be provided by means of flat surfaces on the housings.

The carrier element 1, 6 comprises several indentations 27. The indentations 27 are arranged such that they remain uncovered when the carrier element 1, 6 is mounted to the housing 11, 14. The indentations 27 serve as cooling elements and reduce the wall thickness at their position such that production of the carrier element 1, 6 becomes more efficient. The indentations 27 are arranged on the side of the stop surface 19, 20 opposite the cylindrical section 17, 18.

The mating structure 3, 8 of one of the carrier elements 1, 2 comprises a mating opening 28 and the mating structure 8, 3 of the other of the carrier elements 2, 1 comprises a mating shaft 29 which is engages with the mating opening 28.

Each of the mating structures 3, 8 comprise a coding ring 30, 31 having at least one coding element 32, 33, wherein the coding rings 30, 31 can be positioned at different predetermined coding positions. The coding rings 30, 31 must thereby be positioned at the same determined position such that the coding elements 32, 33 engage with each other. When the coding rings 30, 31 are positioned at different positions, the coding elements 32, 33 will not engage with each other. The coding element 32 is provided as groove and the coding element 33 is provided as comb.

The mating structure further comprises a latching structure, here a latching tab 38 and a latching rib 39. With the latching tab 38 engages with the latching rib 39 in the mated condition.

FIGS. 3 to 4 show the pin side of the connector assembly and FIGS. 5 and 6 show the plug side of the connector assembly. FIGS. 7 to 9 show an additional embodiment. As it can be seen from these figures the housing section 13, 16 are provided differently, whereas the receiving section 12, 15 is provided identical. In summary an assembly kit for a modular connector assembly comprises
at least one socket carrier element 1;
at least one pin carrier element 6;
at least one socket housing 11;
at least one pin housing 14; and
at least one further housing 36 with a further receiving section 37 to which one of said socket carrier element 1 or said pin carrier element 6 can be mounted by means of the bearing section 2, 7 and with a further housing section 41.

The housing sections 13, 16, 41 of the housings 11, 14, 36 are different from each other. In the present embodiments the housing sections 13, 16 of the socket housing and the pin housing are provided as tubular sections and the housing section 41 of the further housing 36 is provided as clamping structure with a thread 42 to which a clamping nut 43 is provided.

The bearing sections 2, 7 of the socket carrier element 1 is identical to the bearing section 7 of the pin carrier element 6. The receiving section 12 of the housings 11, 14, 36 are identical to each other. This means that the assembly provides for a modular connector assembly whereby the connector can be provided that is used for a specific installation system based on the parts within the assembly. It is therefore possible to mix and match the respective parts.

LIST OF REFERENCE SIGNS

| | |
|---|---|
| 1 | socket carrier element |
| 2 | bearing section |
| 3 | mating structure |
| 4 | carrier structure |
| 5 | electrical socket element |
| 6 | pin carrier element |
| 7 | bearing section |
| 8 | mating structure |
| 9 | carrier structure |
| 10 | electrical pin element |
| 11 | socket housing |
| 12 | receiving section |
| 13 | housing section |
| 14 | pin housing |
| 15 | receiving section |
| 16 | housing section |
| 17 | cylindrical section |
| 18 | cylindrical section |
| 19 | stop surface |
| 20 | stop surface |
| 21 | latching structure |
| 22 | latching structure |
| 23 | latching tab |
| 24 | latching rib |
| 25 | first guiding element |
| 26 | second guiding element |
| 27 | indentation |
| 28 | mating opening |
| 29 | mating shaft |
| 30 | coding ring |
| 31 | coding ring |
| 32 | coding element |
| 33 | coding element |
| 36 | further housing |
| 37 | receiving section |
| 38 | latching tab |
| 39 | latching rib |
| 41 | further housing section |
| 42 | thread |
| 43 | clamping nut |

1-13. (canceled)

14. A modular electrical connector assembly comprising
a socket carrier element having a bearing section, a mating structure and a carrier structure to carry at least one electrical socket element;
a pin carrier element having a bearing section, a mating structure and a carrier structure to carry at least one electrical pin element;
a socket housing with a receiving section to which the socket carrier element is mounted by means of the bearing section and with a housing section; and
a pin housing with a receiving section to which the pin carrier element is mounted by means of the bearing section and with a housing section,
wherein the mating structure of the socket carrier element mechanically mates with the mating structure of the pin carrier element,
wherein the at least one electrical socket element and the at least one electrical pin element are arranged such that when the socket carrier element is mated with the pin carrier element an electrical contact is provided between the at least one electrical socket element and the at least one electrical pin element, and
wherein the bearing section of the socket carrier element is identical to the bearing section of the pin carrier element and the receiving section of the socket housing is identical to the receiving section of the pin housing.

15. The modular electrical connector assembly according to claim 14, wherein the bearing section comprises a cylindrical section and wherein the receiving section comprises a cylindrical section, wherein the cylindrical sections mechanically engage with each other.

16. The modular electrical connector assembly according to claim 14, wherein the bearing section comprises a stop surface and wherein the receiving section comprises a stop surface, wherein the stop surfaces engage with each other.

17. The modular electrical connector assembly according to claim 14, wherein the bearing section comprises a latching structure and wherein the receiving section comprises a latching structure, wherein the latching structures mechanically latch with each other.

18. The modular electrical connector assembly according to claim 17, wherein the latching structure is provided by a latching tab and a latching rib, wherein the latching rib engages with the latching tab,
wherein the latching tab is arranged on the housing and extends away from the housing and the latching rib is arranged on the carrier element; or
wherein the latching tab is arranged on the carrier element and extends away from the carrier element and the latching rib is arranged on the housing.

19. The modular electrical connector assembly according to claim 17,
wherein the latching structure is provided by a latching tab and a latching rib, wherein the latching rib engages with the latching tab,
wherein the latching tab is arranged on the housing and extends away from the housing and the latching rib is arranged on the carrier element; or
wherein the latching tab is arranged on the carrier element and extends away from the carrier element and the latching rib is arranged on the housing
wherein at least two of said latching tabs and at least two of said latching ribs are arranged, wherein the latching tabs are arranged diametrically opposite on the housing or on the carrier element; and wherein the latching ribs are arranged diametrically opposite on the housing or on the carrier element.

20. The modular electrical connector assembly according to claim 15, wherein on the carrier element the cylindrical section is adjoined by the stop surface and wherein the latching structure is arranged on the side of the stop surface opposite the cylindrical section.

21. The modular electrical connector assembly according to claim 14, wherein the bearing section comprises a first guiding element and the receiving section comprises a second guiding element, wherein the first guiding element engages with the guiding coding element such that a determined orientation between the carrier element and the housing can be provided.

22. The modular electrical connector assembly according to claim 14, wherein the carrier element comprises several indentations, which are arranged such that they remain uncovered when the carrier element is mounted to the housing.

23. The modular electrical connector assembly according to claim 22, wherein the indentations are arranged on the side of the stop surface opposite the cylindrical section.

24. The modular electrical connector assembly according to claim 14, wherein the mating structure of one of the carrier elements comprises a mating opening and wherein the mating structure of the other of the carrier elements comprises a mating shaft which engages with the mating opening.

25. The modular electrical connector assembly according to claim 14, wherein each of the mating structures comprise a coding ring having at least one coding element, wherein the coding rings can be positioned at different predetermined coding positions.

26. An assembly kit for a modular connector assembly
said modular electrical connector assembly comprising
a socket carrier element having a bearing section, a mating structure and a carrier structure to carry at least one electrical socket element;
a pin carrier element having a bearing section, a mating structure and a carrier structure to carry at least one electrical pin element;
a socket housing with a receiving section to which the socket carrier element is mounted by means of the bearing section and with a housing section; and
a pin housing with a receiving section to which the pin carrier element is mounted by means of the bearing section and with a housing section,
wherein the mating structure of the socket carrier element mechanically mates with the mating structure of the pin carrier element,
wherein the at least one electrical socket element and the at least one electrical pin element are arranged such that when the socket carrier element is mated with the pin carrier element an electrical contact is provided between the at least one electrical socket element and the at least one electrical pin element,
wherein the bearing section of the socket carrier element is identical to the bearing section of the pin carrier element and the receiving section of the socket housing is identical to the receiving section of the pin housing, and
wherein said assembly kit comprising
at least one socket carrier element;
at least one pin carrier element;
at least one socket housing;
at least one pin housing; and
at least one further housing with a further receiving section to which one of said socket carrier element or said pin carrier element can be mounted by means of the bearing section and with a further housing section;
wherein the housing sections of the housings are different from each other;
wherein the bearing sections of the socket carrier element is identical to the bearing section of the pin carrier element; and
wherein the receiving section of the housings are identical to each other.
